(19) United States
(12) Patent Application Publication
(10) Pub. No.: US 2015/0310368 A1
(43) Pub. Date: Oct. 29, 2015

(54) ROAD MANAGEMENT EQUIPMENT CONTROL

(71) Applicant: International Business Machines Corporation, Armonk, NY (US)

(72) Inventors: Scott Ryan Crowther, LaGrangeville, NY (US); Grant Douglas Miller, Arvada, CO (US); Nader M Nassar, Yorktown Heights, NY (US); Tamer Nassar, Bethel, CT (US)

(73) Assignee: International Business Machines Corporation, Armonk, NY (US)

(21) Appl. No.: 14/261,785

(22) Filed: Apr. 25, 2014

(51) Int. Cl. G06Q 10/06

(52) U.S. Cl. CPC G06Q 10/06313

(57) ABSTRACT

A method includes a computing device receiving historical data for a portion of a road; the computing device receiving current data for road conditions using sensors; the computing device predicting future hazardous road conditions for the portion of the road using the received historical and current data; and the computing device scheduling road management actions for the portion of the road as a result of the predicted road conditions.

### BACKGROUND

The present invention relates to equipment management, and more specifically, to using sensor inputs to schedule road management actions.

### SUMMARY

According to one aspect of the present invention, a method includes a computing device receiving historical data for a portion of a road; the computing device receiving current data for road conditions using sensors; the computing device predicting future hazardous road conditions for the portion of the road using the received historical and current data; and the computing device scheduling road management actions for the portion of the road as a result of the predicted road conditions.

According to another aspect of the present invention, a system including one or more processors, one or more computer-readable memories and one or more computer-readable, tangible storage devices; a receiving module operatively coupled to at least one of the one or more storage devices for execution by at least one of the one or more processors via at least one of the one or more memories, configured to receive historical data for a portion of a road; the receiving module operatively coupled to at least one of the one or more storage devices for execution by at least one of the one or more processors via at least one of the one or more memories, configured to receive current data for road conditions using sensors; a predicting module operatively coupled to at least one of the one or more storage devices for execution by at least one of the one or more processors via at least one of the one or more memories, configured to predict future hazardous road conditions for the portion of the road using the received historical and current data; and a scheduling module operatively coupled to at least one of the one or more storage devices for execution by at least one of the one or more processors via at least one of the one or more memories, configured to schedule road management actions for the portion of the road as a result of the predicted road conditions.

According to yet another aspect of the present invention, a computer program product including: one or more computer-readable, tangible storage medium; program instructions, stored on at least one of the one or more storage medium, to receive historical data for a portion of a road; program instructions, stored on at least one of the one or more storage medium, to receive current data for road conditions using sensors; program instructions, stored on at least one of the one or more storage medium, to predict future hazardous road conditions for the portion of the road using the received historical and current data; and program instructions, stored on at least one of the one or more storage medium, to schedule road management actions for the portion of the road as a result of the predicted road conditions.

### BRIEF DESCRIPTION OF THE SEVERAL VIEWS OF THE DRAWINGS

FIG. 1 shows a flowchart according to an embodiment of the present invention.

FIG. 2 shows a flowchart according to another embodiment of the present invention.

FIG. 3 shows exemplary implementation according to an embodiment of the present invention.

FIG. 4 illustrates a hardware configuration according to an embodiment of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

When severe weather occurs in cities and rural areas, the state, city, or private companies use varying kinds of equipment, such as snow plows, to manage the condition of the roads. The driver has to make a determination of where to plow the roads, when to use gravel or other materials for increasing traction, or using materials such as magnesium chloride to lower the freezing temperatures. The companies or agencies managing these services have a limited amount of resources that can be applied to road conditions, and often times it is left up to the driver or operator of the equipment to make a judgement about when/where to deploy the services. The driver has to make these decisions while at the same time having to operate the equipment during severe weather.

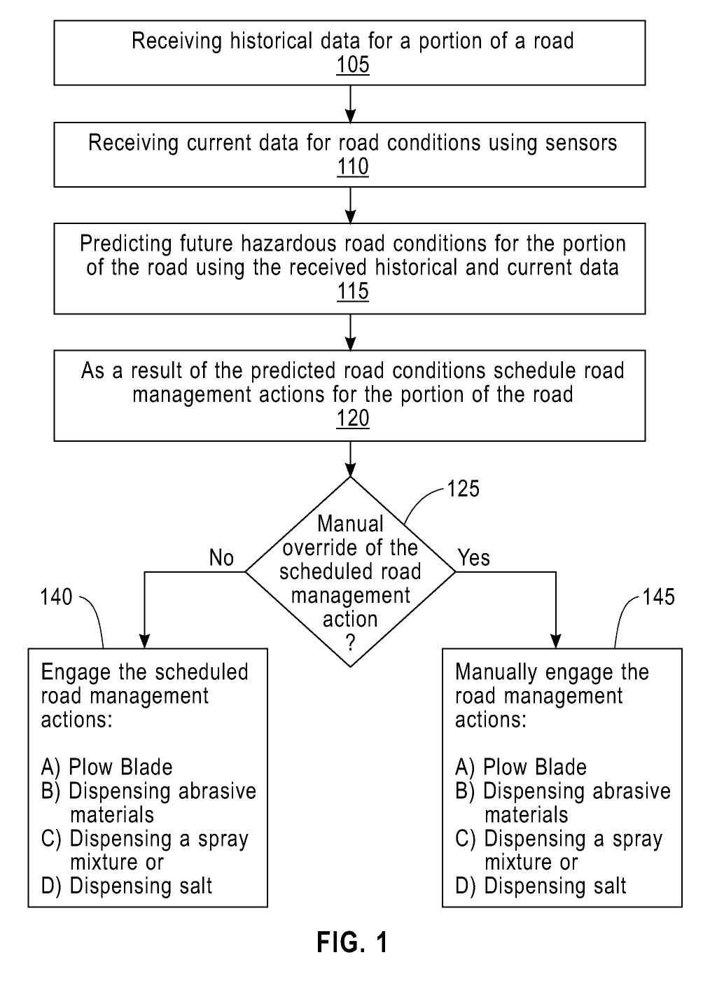

Now referring to FIG. 1, an embodiment of the present invention includes the process of receiving historical data for a portion of a road (105). The process further includes receiving current data for road conditions using sensors on a road maintenance vehicle (110). The process then predicts future hazardous road conditions for the portion of the road using the received historical and current data (115). As a result of the predicted road conditions road management actions can be scheduled for the portion of the road being observed (120). Before the scheduled road management actions are taken, the process determines if manual override has been engaged (125). If no manual override has been engaged, then the scheduled road management actions are allowed to take place while the driver focuses on driving the maintenance vehicle (140). The road management actions may include lowering a plow blade, dispensing abrasive materials, dispensing a spray mixture, dispensing salt or some other method for removing or melting the ice and/or snow. If the manual override has been engaged then the process allows the driver to manually engage select ones of the road management actions (145).

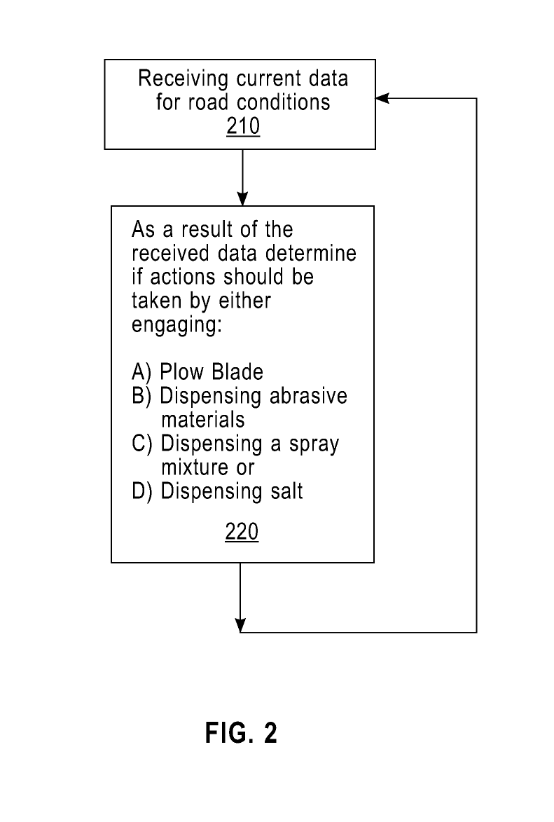

Referring to FIG. 2, another process according to an embodiment of the present invention includes a maintenance vehicle receiving current data regarding road conditions (210). The received data may include outside temperature, snow depth, icing, or historical information for specific roads including, but are not limited to, vehicle congestion use, previous road management actions or accident reporting. As a result of the received data the process determines if actions should be taken (220). The road management actions that could be taken include engaging a plow blade, dispensing abrasive materials, dispensing a spray mixture, dispensing salt or some other method for removing or melting the ice and/or snow. This process repeats itself while the maintenance vehicle is in use. Thereby, allowing the driver of the vehicle to focus on driving the vehicle and not road management actions.

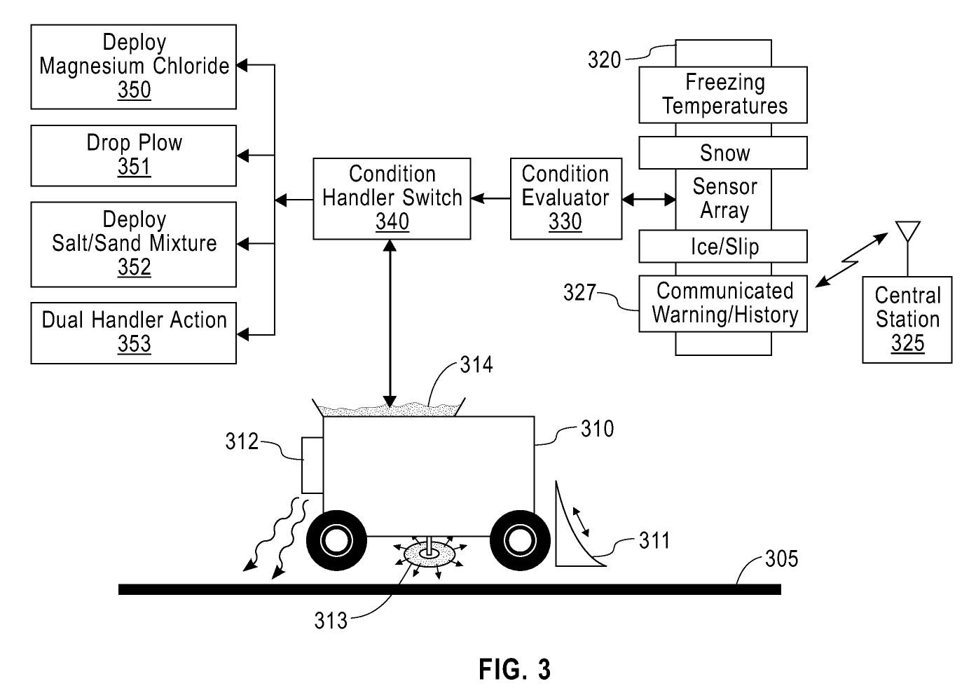

Referring to FIG. 3, an exemplary implementation according to an embodiment of the present invention is depicted. A weather maintenance vehicle 310 includes a raiseable snow plow 311, a liquid dispensing holding tank 312, a broadcast spreader 313 and a section 314 for holding materials to be deployed by using the broadcast spreader 313. The maintenance vehicle 310 is further equipped with an array of sensors 320 and communication equipment 327 for receiving broadcasted information from a central station 325 being transmitted via an antenna 326. As a driver drives the maintenance vehicle 310 on a portion of a road 305, the sensor array 320 detects the conditions of the road by using temperature sensors, taking snow measurements, and detecting icing/slip conditions. The sensor array 320 further receives historical data for the portion of the road that the maintenance vehicle 310 is currently traveling. The readings from the sensor array are supplied to a condition evaluator 320. If the condition evaluator 320 detects a tripped condition based on the sensor readings it notifies a condition handler switch unit 340 within the maintenance vehicle 310. The condition handler switch unit 340 has the ability to enable the following functions: deploy magnesium chloride 350 from the holding tank 312, drop the plow (351, 311), deploy salt and/or sand 352 using the broadcast spreader 313 or trigger a dual action 353. The dual handler action 353 may include dropping the plow (351, 311) and deploying the salt and/or sand 352.

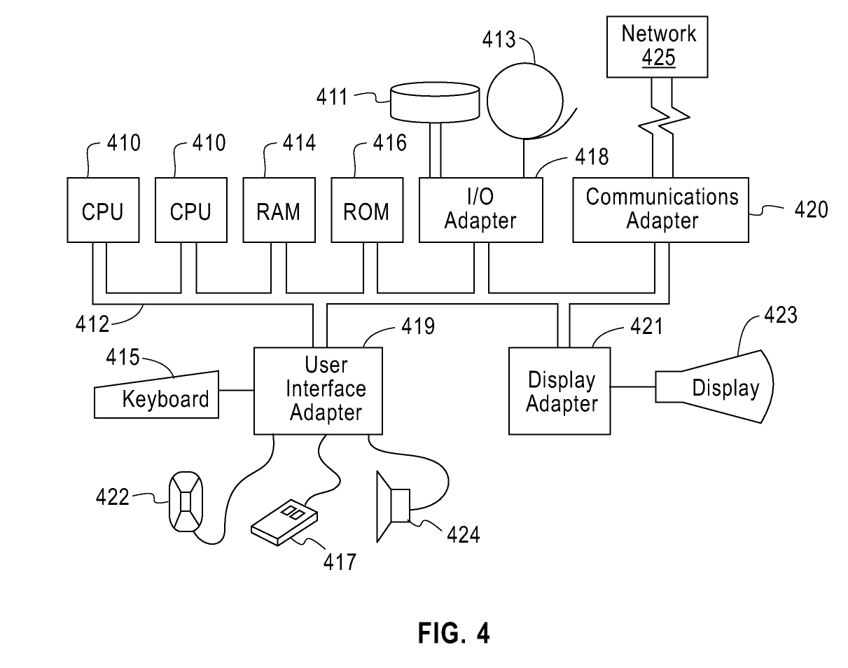

Referring now to FIG. 4, this schematic drawing illustrates a hardware configuration of an information handling/computer imaging system in accordance with the embodiments of the invention. The system comprises at least one processor or central processing unit (CPU) 410. The CPUs 410 are interconnected via system bus 412 to various devices such as a random access memory (RAM) 414, read-only memory (ROM) 416, and an input/output (I/O) adapter 418. The I/O adapter 418 can connect to peripheral devices, such as disk units 411 and tape drives 413, or other program storage devices that are readable by the system. The system can read the inventive instructions on the program storage devices and follow these instructions to execute the methodology of the embodiments of the invention. The system further includes a user interface adapter 419 that connects a keyboard 415, mouse 417, speaker 424, microphone 422, and/or other user interface devices such as a touch screen device (not shown) to the bus 412 to gather user input. Additionally, a communication adapter 420 connects the bus 412 to a data processing network 425, and a display adapter 421 connects the bus 412 to a display device 423 which may be embodied as an output device such as a monitor, printer, or transmitter, for example.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
a computing device receiving historical data for a portion of a road;
the computing device receiving current data for road conditions using sensors;
the computing device predicting future hazardous road conditions for the portion of the road using the received historical and current data; and
the computing device scheduling road management actions for the portion of the road as a result of the predicted road conditions.

2. The method according to claim 1, wherein the schedule road management actions include control of a plow.

3. The method according to claim 1, wherein the schedule road management actions include control of a sand deployer.

4. The method according to claim 1, wherein the schedule road management actions include control of an de-icing solution deployer.

5. The method according to claim 1, wherein the schedule road management actions include control of a salt deployer.

6. The method according to claim 1, further comprising the computer device receiving manual input actions to allow for manually overriding the scheduled road management actions.

7. The method according to claim 1, wherein the historical data is transmitted from a central authority.

8. A system comprising:
one or more processors, one or more computer-readable memories and one or more computer-readable, tangible storage devices;
a receiving module operatively coupled to at least one of the one or more storage devices for execution by at least one of the one or more processors via at least one of the one or more memories, configured to receive historical data for a portion of a road;
the receiving module operatively coupled to at least one of the one or more storage devices for execution by at least one of the one or more processors via at least one of the one or more memories, configured to receive current data for road conditions using sensors;
a predicting module operatively coupled to at least one of the one or more storage devices for execution by at least one of the one or more processors via at least one of the one or more memories, configured to predict future hazardous road conditions for the portion of the road using the received historical and current data; and
a scheduling module operatively coupled to at least one of the one or more storage devices for execution by at least one of the one or more processors via at least one of the one or more memories, configured to schedule road management actions for the portion of the road as a result of the predicted road conditions.

9. The system according to claim 8, wherein the schedule road management actions include control of a plow.

10. The system according to claim 8, wherein the schedule road management actions include control of a sand deployer.

11. The system according to claim 8, wherein the schedule road management actions include control of an de-icing solution deployer.

12. The system according to claim 8, wherein the schedule road management actions include control of a salt deployer.

13. The system according to claim 8, further comprising the computer device receiving manual input actions to allow for manually overriding the scheduled road management actions.

14. The system according to claim 8, wherein the historical data is transmitted from a central authority.

15. A computer program product comprising:
one or more computer-readable, tangible storage medium;
program instructions, stored on at least one of the one or more storage medium, to receive historical data for a portion of a road;
program instructions, stored on at least one of the one or more storage medium, to receive current data for road conditions using sensors;
program instructions, stored on at least one of the one or more storage medium, to predict future hazardous road conditions for the portion of the road using the received historical and current data; and
program instructions, stored on at least one of the one or more storage medium, to schedule road management actions for the portion of the road as a result of the predicted road conditions.

16. The computer program product according to claim 15, wherein the schedule road management actions include control of a plow.

17. The computer program product according to claim 15, wherein the schedule road management actions include control of a sand deployer.

18. The computer program product according to claim 15, wherein the schedule road management actions include control of an de-icing solution deployer.

19. The computer program product according to claim 15, further comprising program instructions, stored on at least one of the one or more storage medium, to receive manual input actions to allow for manually overriding the scheduled road management actions.

20. The computer program product according to claim 15, wherein the historical data is transmitted from a central authority.
